(19) United States
(12) Patent Application Publication
(10) Pub. No.: US 2026/0135481 A1
(43) Pub. Date: May 14, 2026

(54) SWITCHED-CAPACITOR CONVERTER, CHIP, AND ELECTRONIC DEVICE

(71) Applicant: Zhuhai Nanxin Semiconductor Technology Co., Ltd., Zhuhai (CN)

(72) Inventor: Wei Zhao, Zhuhai (CN)

(73) Assignee: Zhuhai Nanxin Semiconductor Technology Co., Ltd., Zhuhai (CN)

(21) Appl. No.: 19/389,093

(22) Filed: Nov. 14, 2025

(30) Foreign Application Priority Data
Nov. 14, 2024 (CN) 202411631337.2

(51) Int. Cl. H02M 3/07; H02M 1/00; H02M 3/157

(52) U.S. Cl. CPC H02M 3/072; H02M 1/0012; H02M 1/0083; H02M 3/157

(57) ABSTRACT

Provided are a switched-capacitor converter, a chip, and an electronic device. The logic control circuit may control turn-on or turn-off of the plurality of transistors to change the connections among the first flying capacitor, the second flying capacitor, and the third flying capacitor, such that the voltage conversion circuit converts the input voltage into the first output voltage and the second output voltage. In this way, the switched-capacitor converter may convert the input voltage into the first output voltage and the second output voltage using only three flying capacitors, which reduces the quantity of flying capacitors and transistors in the switched-capacitor converter, thereby reducing the total quantity of components. Therefore, the area occupied by the switched-capacitor converter is be reduced, which is conducive to miniaturization for the switched-capacitor converter.

### CROSS REFERENCE TO THE RELATED APPLICATIONS

This application is based upon and claims priority to Chinese Patent Application No. 202411631337.2, filed on November 14, 2024, the entire contents of which are incorporated herein by reference.

### TECHNICAL FIELD

The present disclosure relates to the technical field of power management chips, and in particular, relates to a switched-capacitor converter, a chip, and an electronic device.

### BACKGROUND

A switched-capacitor converter (also known as a charge pump) achieves charging and discharging of flying capacitors by controlling turn-on or turn-off of transistors. In this way, the switched-capacitor converter may convert an input voltage into a first output voltage and a second output voltage to satisfy load requirements.

In the related art, the quantity of components used in the switched-capacitor converter is large, which results in a large area occupied by the switched-capacitor converter and is not conducive to miniaturization for the switched-capacitor converter.

### SUMMARY

The present disclosure provides a switched-capacitor converter, a chip, and an electronic device. By reducing the quantity of flying capacitors, the quantity of components in the switched-capacitor converter is decreased, which in turn reduces the occupied area of the converter and promotes miniaturization of the converter.

In a first aspect, some embodiments of the present disclosure provide a switched-capacitor converter. The switched-capacitor converter includes a voltage conversion circuit; wherein an input terminal of the voltage conversion circuit is electrically connected to an input terminal of the switched-capacitor converter, a first output terminal of the voltage conversion circuit is electrically connected to a first output terminal of the switched-capacitor converter, and a second output terminal of the voltage conversion circuit is electrically connected to a second output terminal of the switched-capacitor converter; and the voltage conversion circuit includes a plurality of transistors, a logic control circuit, a first flying capacitor, a second flying capacitor, and a third flying capacitor, wherein control terminals of the plurality of transistors are all electrically connected to the logic control circuit, and wherein a quantity of each of the first flying capacitor, the second flying capacitor, and the third flying capacitor is one.

The plurality of transistors include a first transistor, a second transistor, a third transistor, a fourth transistor, a fifth transistor, a sixth transistor, a seventh transistor, an eighth transistor, a ninth transistor, a tenth transistor, an eleventh transistor, and a twelfth transistor.

A first terminal of the first transistor is electrically connected to the input terminal of the switched-capacitor converter, a second terminal of the first transistor is electrically connected to a first terminal of the third transistor, a second terminal of the third transistor is electrically connected to a first terminal of the sixth transistor, a second terminal of the sixth transistor is electrically connected to a first terminal of the tenth transistor, a second terminal of the tenth transistor is electrically connected to a first terminal of the eleventh transistor, and a second terminal of the eleventh transistor is electrically connected to a first terminal of the twelfth transistor.

A first terminal of the second transistor is electrically connected to a second terminal of the fourth transistor, a first terminal of the fourth transistor is electrically connected to a first terminal of the seventh transistor, a second terminal of the seventh transistor is electrically connected to a first terminal of the eighth transistor, and a second terminal of the eighth transistor is electrically connected to a first terminal of the ninth transistor.

A first plate of the first flying capacitor and a first terminal of the fifth transistor are both electrically connected between the second terminal of the first transistor and the first terminal of the third transistor, a second plate of the first flying capacitor is electrically connected between the first terminal of the second transistor and the second terminal of the fourth transistor, a second terminal of the fifth transistor and a first plate of the second flying capacitor are both electrically connected between the first terminal of the fourth transistor and the first terminal of the seventh transistor, and a second plate of the second flying capacitor is electrically connected between the second terminal of the eighth transistor and the first terminal of the ninth transistor.

A first plate of the third flying capacitor is electrically connected between the second terminal of the sixth transistor and the first terminal of the tenth transistor, and a second plate of the third flying capacitor is electrically connected between the second terminal of the eleventh transistor and the first terminal of the twelfth transistor.

The first output terminal of the switched-capacitor converter is electrically connected between the second terminal of the third transistor and the first terminal of the sixth transistor, the second terminal of the seventh transistor and the second terminal of the tenth transistor are further electrically connected to the second output terminal of the switched-capacitor converter, and a second terminal of the second transistor, a second terminal of the ninth transistor, and a second terminal of the twelfth transistor are all electrically connected to a ground terminal of the switched-capacitor converter.

The logic control circuit is configured to control turn-on or turn-off of the plurality of transistors, to change connections among the first flying capacitor, the second flying capacitor, and the third flying capacitor, such that the switched-capacitor converter converts an input voltage into a first output voltage and a second output voltage, wherein the input voltage is a voltage at the input terminal of the switched-capacitor converter, the first output voltage is a voltage at the first output terminal of the switched-capacitor converter, and the second output voltage is a voltage at the second output terminal of the switched-capacitor converter.

In the switched-capacitor converter according to the first aspect, the logic control circuit may control turn-on or turn-off of the plurality of transistors to change the connections among the first flying capacitor, the second flying capacitor, and the third flying capacitor, such that the voltage conversion circuit converts the input voltage into the first output voltage and the second output voltage. Thus, the switched-capacitor converter may convert the input voltage into the first output voltage and the second output voltage. In this way, the switched-capacitor converter may convert the input voltage into the first output voltage and the second output voltage using only three flying capacitors, which reduces the quantity of flying capacitors and transistors in the switched-capacitor converter, thereby reducing the total quantity of components. Therefore, the area occupied by the switched-capacitor converter is be reduced, which is conducive to miniaturization for the switched-capacitor converter. At the same time, because the quantity of components in the switched-capacitor converter is reduced, the connections among the components are simplified, lowering the cost of the switched-capacitor converter.

In some embodiments, in a first operating mode, a voltage conversion ratio among the input voltage, the first output voltage, and the second output voltage is 4:2:1, wherein the first operating mode is a mode in which the plurality of transistors, except for the fifth transistor, switch between a first phase and a second phase.

In the first phase and the second phase, the fifth transistor is turned off.

In the first phase, the first transistor, the fourth transistor, the eighth transistor, the tenth transistor, and the twelfth transistor are all turned on; and the second transistor, the third transistor, the sixth transistor, the seventh transistor, the ninth transistor, and the eleventh transistor are all turned off.

In the second phase, the first transistor, the fourth transistor, the eighth transistor, the tenth transistor, and the twelfth transistor are all turned off; and the second transistor, the third transistor, the sixth transistor, the seventh transistor, the ninth transistor, and the eleventh transistor are all turned on.

In some embodiments, in a second operating mode, a voltage conversion ratio among the input voltage, the first output voltage, and the second output voltage is 3:2:1, wherein the second operating mode is a mode in which the plurality of transistors switch between a first phase and a second phase.

In the first phase, the first transistor, the fourth transistor, the seventh transistor, the ninth transistor, the tenth transistor, and the twelfth transistor are all turned on; and the second transistor, the third transistor, the fifth transistor, the sixth transistor, the eighth transistor, and the eleventh transistor are all turned off.

In the second phase, the first transistor, the fourth transistor, the seventh transistor, the ninth transistor, the tenth transistor, and the twelfth transistor are all turned off; and the second transistor, the third transistor, the fifth transistor, the sixth transistor, the eighth transistor, and the eleventh transistor are all turned on.

In some embodiments, in a third operating mode, a voltage conversion ratio among the input voltage, the first output voltage, and the second output voltage is 2:2:1, wherein the third operating mode is a mode in which the plurality of transistors, except for the first transistor, the second transistor, the third transistor, and the fourth transistor, switch between a first phase and a second phase.

In the first phase and the second phase, the first transistor and the third transistor are both turned on, and the second transistor and the fourth transistor are both turned off.

In the first phase, the fifth transistor, the eighth transistor, the tenth transistor, and the twelfth transistor are all turned on; and the sixth transistor, the seventh transistor, the ninth transistor, and the eleventh transistor are all turned off.

In the second phase, the fifth transistor, the eighth transistor, the tenth transistor, and the twelfth transistor are all turned off; and the sixth transistor, the seventh transistor, the ninth transistor, and the eleventh transistor are all turned on.

In some embodiments, in a fourth operating mode, a voltage conversion ratio among the input voltage, the first output voltage, and the second output voltage is 1:1:1; in the fourth operating mode, the first transistor, the third transistor, the fifth transistor, the sixth transistor, the seventh transistor, and the tenth transistor are all turned on; and the second transistor, the fourth transistor, the eighth transistor, the ninth transistor, the eleventh transistor, and the twelfth transistor are all turned off.

In some embodiments, a quantity of the voltage conversion circuit is at least two; wherein an input terminal of each of the voltage conversion circuits is electrically connected to the input terminal of the switched-capacitor converter, a first output terminal of each of the voltage conversion circuits is electrically connected to the first output terminal of the switched-capacitor converter, a second output terminal of each of the voltage conversion circuits is electrically connected to the second output terminal of the switched-capacitor converter, and the respective voltage conversion circuits are connected in parallel.

In some embodiments, the switched-capacitor converter further includes a first output capacitor and a second output capacitor; wherein a first plate of the first output capacitor is electrically connected to the first output terminal of the switched-capacitor converter, a first plate of the second output capacitor is electrically connected to the second output terminal of the switched-capacitor converter, and a second plate of the first output capacitor and a second plate of the second output capacitor are both electrically connected to the ground terminal of the switched-capacitor converter.

In a second aspect, some embodiments of the present disclosure provide a switched-capacitor converter chip. The chip includes the switched-capacitor converter according to the first aspect.

For details about the beneficial effects achieved by the method according to the second aspect and the embodiments of the second aspect, reference may be made to the beneficial effects achieved by the first aspect or any embodiment of the first aspect, which are not described herein any further.

In a third aspect, some embodiments of the present disclosure provide an electronic device. The electronic device includes the switched-capacitor converter chip according to the second aspect.

The above description only summarizes the technical solutions of the embodiments of the present disclosure. Specific embodiments of the present disclosure are described hereinafter to better and clearer understand the technical solutions of the embodiments of the present disclosure, to practice the technical solutions based on the disclosure of the specification and to make the above and other objectives, features and advantages of the embodiments of the present disclosure more apparent and understandable.

### BRIEF DESCRIPTION OF THE DRAWINGS

For clearer descriptions of technical solutions according to the embodiments of the present disclosure, drawings that are to be referred for description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a schematic structural diagram of a switched-capacitor converter in the related art.

FIG. 2 is a schematic structural diagram of a switched-capacitor converter according to some embodiments of the present disclosure.

FIG. 3 is a schematic structural diagram of a switched-capacitor converter in a first operating mode according to some embodiments of the present disclosure.

FIG. 4 is another schematic structural diagram of a switched-capacitor converter in the first operating mode according to some embodiments of the present disclosure.

FIG. 5 is a schematic equivalent circuit diagram of the switched-capacitor converter illustrated in FIG. 3.

FIG. 6 is a schematic equivalent circuit diagram of the switched-capacitor converter illustrated in FIG. 4.

FIG. 7 is a schematic structural diagram of a switched-capacitor converter in a second operating mode according to some embodiments of the present disclosure.

FIG. 8 is another schematic structural diagram of a switched-capacitor converter in the second operating mode according to some embodiments of the present disclosure.

FIG. 9 is a schematic equivalent circuit diagram of the switched-capacitor converter illustrated in FIG. 7.

FIG. 10 is a schematic equivalent circuit diagram of the switched-capacitor converter illustrated in FIG. 8.

FIG. 11 is a schematic structural diagram of a switched-capacitor converter in a third operating mode according to some embodiments of the present disclosure.

FIG. 12 is another schematic structural diagram of a switched-capacitor converter in the third operating mode according to some embodiments of the present disclosure.

FIG. 13 is a schematic equivalent circuit diagram of the switched-capacitor converter illustrated in FIG. 11.

FIG. 14 is a schematic equivalent circuit diagram of the switched-capacitor converter illustrated in FIG. 12.

FIG. 15 is a schematic structural diagram of a switched-capacitor converter in a fourth operating mode according to some embodiments of the present disclosure.

FIG. 16 is a schematic equivalent circuit diagram of the switched-capacitor converter illustrated in FIG. 15.

FIG. 17 is a schematic structural diagram of another switched-capacitor converter according to some embodiments of the present disclosure.

### DETAILED DESCRIPTION OF THE EMBODIMENTS

In the present disclosure, the term "at least one" refers to one or more than one, and the term "a plurality of" refers to two or more than two. The term "and/or" is merely an association relationship for describing associated objects, which represents that there may exist three types of relationships. For example, the phrase "A and/or B" means (A), (B), or (A and B), wherein A and B may be single or plural. In addition, the symbol "/" generally represents an "or" relationship between associated objects before and after the symbol. The expression "at least one of the following" or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms "first," "second," and the like are merely for the illustration purpose, and shall not be construed as indicating or implying a relative importance.

In the description of the present disclosure, it should be understood that the terms "central," "transversal," "longitudinal," "upper," "lower," "left," "right," "front," "rear," and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms "connected," "coupled," and derivatives forms thereof shall be understood in a broad sense. For example, the terms "connected," "coupled," and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is turned on, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

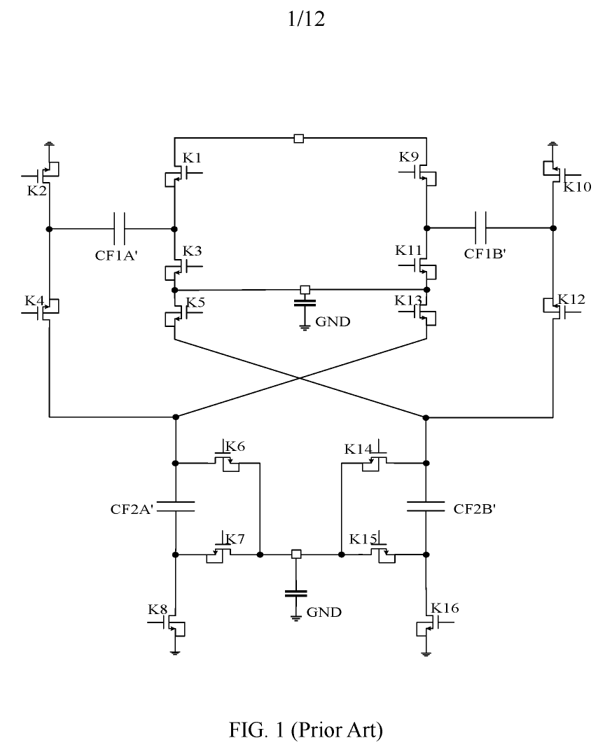

Referring to FIG. 1, FIG. 1 is a schematic structural diagram of a switched-capacitor converter in the related art. As illustrated in FIG. 1, the switched-capacitor converter in the related art may include: transistors K1, K2, K3, K4, K5, K6, K7, K8, K9, K10, K11, K12, K13, K14, K15, and K16, and flying capacitors CF1A', CF2A', and CF2B'.

In the related art, because the switched-capacitor converter requires 16 transistors and 4 flying capacitors, the quantity of components used is large, which results in a large area occupied by the switched-capacitor converter and is not conducive to miniaturization for the switched-capacitor converter. At the same time, due to the large quantity of components used in the switched-capacitor converter, the connections among the components are complex, leading to an increase in the cost of the switched-capacitor converter.

To solve the above-mentioned problems, the present disclosure provides a switched-capacitor converter, a chip, and an electronic device.

In the present disclosure, the electronic device may include, but is not limited to, a portable device, an audio device, a wireless communication device, and an automotive electronic device.

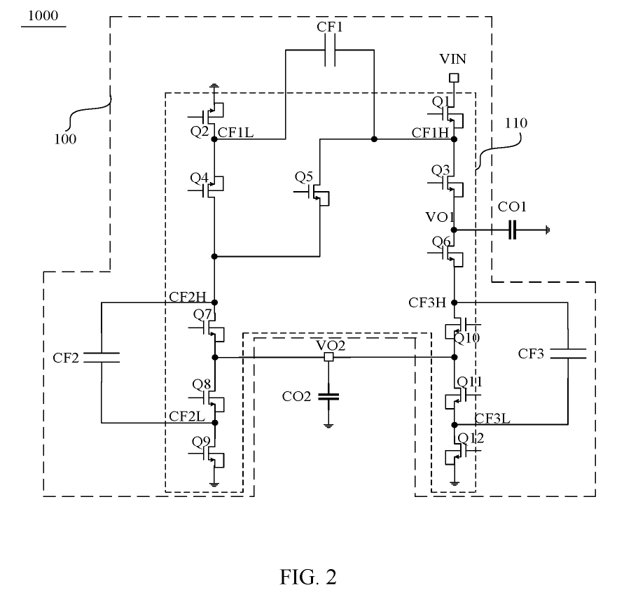

Referring to FIG. 2, FIG. 2 is a schematic structural diagram of a switched-capacitor converter 1000 according to some embodiments of the present disclosure. As illustrated in FIG. 2, the switched-capacitor converter 1000 may include a voltage conversion circuit 100. An input terminal of the voltage conversion circuit 100 is electrically connected to an input terminal of the switched-capacitor converter 1000. A first output terminal of the voltage conversion circuit 100 is electrically connected to a first output terminal of the switched-capacitor converter 1000. A second output terminal of the voltage conversion circuit 100 is electrically connected to a second output terminal of the switched-capacitor converter 1000.

The voltage conversion circuit 100 may include a plurality of transistors 110, a first flying capacitor CF1, a second flying capacitor CF2, and a third flying capacitor CF3. Control terminals of the plurality of transistors 110 are all electrically connected to a logic control circuit.

The plurality of transistors 110, the first flying capacitor CF1, the second flying capacitor CF2, and the third flying capacitor CF3 may be integrated or arranged separately, which may be configured according to actual needs.

The quantity of each of the first flying capacitor CF1, the second flying capacitor CF2, and the third flying capacitor CF3 is one.

The logic control circuit is configured to drive turn-on or turn-off of the transistors within the plurality of transistors 110.

The control signal provided by the logic control circuit may be a turn-on control signal or a turn-off control signal. In a case where the control signal is the turn-on control signal, the logic control circuit may drive a corresponding transistor to be turned on. In a case where the control signal is the turn-off control signal, the logic control circuit may drive a corresponding transistor to be turned off.

The plurality of transistors 110 are configured to control the connections among the first flying capacitor CF1, the second flying capacitor CF2, and the third flying capacitor CF3, to cause the switched-capacitor converter 1000 to convert an input voltage VIN into a first output voltage VO1 and a second output voltage VO2.

The input voltage VIN is a voltage at the input terminal of the switched-capacitor converter 1000, the first output voltage VO1 is a voltage at the first output terminal of the switched-capacitor converter 1000, and the second output voltage VO2 is a voltage at the second output terminal of the switched-capacitor converter 1000.

In some embodiments, as illustrated in FIG. 2, the plurality of transistors 110 may include a first transistor Q1, a second transistor Q2, a third transistor Q3, a fourth transistor Q4, a fifth transistor Q5, a sixth transistor Q6, a seventh transistor Q7, an eighth transistor Q8, a ninth transistor Q9, a tenth transistor Q10, an eleventh transistor Q11, and a twelfth transistor Q12.

A first terminal of the first transistor Q1 is electrically connected to the input terminal of the switched-capacitor converter 1000, a second terminal of the first transistor Q1 is electrically connected to a first terminal of the third transistor Q3, a second terminal of the third transistor Q3 is electrically connected to a first terminal of the sixth transistor Q6, a second terminal of the sixth transistor Q6 is electrically connected to a first terminal of the tenth transistor Q10, a second terminal of the tenth transistor Q10 is electrically connected to a first terminal of the eleventh transistor Q11, and a second terminal of the eleventh transistor Q11 is electrically connected to a first terminal of the twelfth transistor Q12.

A first terminal of the second transistor Q2 is electrically connected to a second terminal of the fourth transistor Q4, a first terminal of the fourth transistor Q4 is electrically connected to a first terminal of the seventh transistor Q7, a second terminal of the seventh transistor Q7 is electrically connected to a first terminal of the eighth transistor Q8, and a second terminal of the eighth transistor Q8 is electrically connected to a first terminal of the ninth transistor Q9.

A first plate of the first flying capacitor CF1 and a first terminal of the fifth transistor Q5 are both electrically connected to a first connection node CF1H between the second terminal of the first transistor Q1 and the first terminal of the third transistor Q3. A second plate of the first flying capacitor CF1 is electrically connected to a second connection node CF1L between the first terminal of the second transistor Q2 and the second terminal of the fourth transistor Q4. A second terminal of the fifth transistor Q5 and a first plate of the second flying capacitor CF2 are both electrically connected to a third connection node CF2H between the first terminal of the fourth transistor Q4 and the first terminal of the seventh transistor Q7. A second plate of the second flying capacitor CF2 is electrically connected to a fourth connection node CF2L between the second terminal of the eighth transistor Q8 and the first terminal of the ninth transistor Q9.

A first plate of the third flying capacitor CF3 is electrically connected to a fifth connection node CF3H between the second terminal of the sixth transistor Q6 and the first terminal of the tenth transistor Q10. A second plate of the third flying capacitor CF3 is electrically connected to a sixth connection node CF3L between the second terminal of the eleventh transistor Q11 and the first terminal of the twelfth transistor Q12.

The first output terminal of the switched-capacitor converter 1000 is electrically connected between the second terminal of the third transistor Q3 and the first terminal of the sixth transistor Q6. The second terminal of the seventh transistor Q7 and the second terminal of the tenth transistor Q10 are further electrically connected to the second output terminal of the switched-capacitor converter 1000. A second terminal of the second transistor Q2, a second terminal of the ninth transistor Q9, and a second terminal of the twelfth transistor Q12 are all electrically connected to a ground terminal of the switched-capacitor converter.

The control terminals of the first transistor Q1, the second transistor Q2, the third transistor Q3, the fourth transistor Q4, the fifth transistor Q5, the sixth transistor Q6, the seventh transistor Q7, the eighth transistor Q8, the ninth transistor Q9, the tenth transistor Q10, the eleventh transistor Q11, and the twelfth transistor Q12 are all electrically connected to the logic control circuit.

The first transistor Q1, the second transistor Q2, the third transistor Q3, the fourth transistor Q4, the fifth transistor Q5, the sixth transistor Q6, the seventh transistor Q7, the eighth transistor Q8, the ninth transistor Q9, the tenth transistor Q10, the eleventh transistor Q11, and the twelfth transistor Q12 may be integrated or arranged separately, which may be configured according to actual needs.

The first transistor Q1, the second transistor Q2, the third transistor Q3, the fourth transistor Q4, the fifth transistor Q5, the sixth transistor Q6, the seventh transistor Q7, the eighth transistor Q8, the ninth transistor Q9, the tenth transistor Q10, the eleventh transistor Q11, and the twelfth transistor Q12 may include, but are not limited to, gallium nitride (GaN) transistors, metal-oxide-semiconductor field-effect transistors (MOSFETs), field-controlled thyristors, or gate turn-off thyristors (GTOs).

For example, in a case where the first transistor Q1, the second transistor Q2, the third transistor Q3, the fourth transistor Q4, the fifth transistor Q5, the sixth transistor Q6, the seventh transistor Q7, the eighth transistor Q8, the ninth transistor Q9, the tenth transistor Q10, the eleventh transistor Q11, and the twelfth transistor Q12 are Gallium Nitride (GaN) transistors, the control terminal of the first transistor Q1, the control terminal of the second transistor Q2, the control terminal of the third transistor Q3, the control terminal of the fourth transistor Q4, the control terminal of the fifth transistor Q5, the control terminal of the sixth transistor Q6, the control terminal of the seventh transistor Q7, the control terminal of the eighth transistor Q8, the control terminal of the ninth transistor Q9, the control terminal of the tenth transistor Q10, the control terminal of the eleventh transistor Q11, and the control terminal of the twelfth transistor Q12 refer to the gate of the GaN transistor; the first terminal of the first transistor Q1, the first terminal of the second transistor Q2, the first terminal of the third transistor Q3, the first terminal of the fourth transistor Q4, the first terminal of the fifth transistor Q5, the first terminal of the sixth transistor Q6, the first terminal of the seventh transistor Q7, the first terminal of the eighth transistor Q8, the first terminal of the ninth transistor Q9, the first terminal of the tenth transistor Q10, the first terminal of the eleventh transistor Q11, and the first terminal of the twelfth transistor Q12 may be the drain or source of the GaN transistor; and correspondingly, the second terminal of the first transistor Q1, the second terminal of the second transistor Q2, the second terminal of the third transistor Q3, the second terminal of the fourth transistor Q4, the second terminal of the fifth transistor Q5, the second terminal of the sixth transistor Q6, the second terminal of the seventh transistor Q7, the second terminal of the eighth transistor Q8, the second terminal of the ninth transistor Q9, the second terminal of the tenth transistor Q10, the second terminal of the eleventh transistor Q11, and the second terminal of the twelfth transistor Q12 may be the source or drain of the GaN transistor.

For example, in a case where the first transistor Q1, the second transistor Q2, the third transistor Q3, the fourth transistor Q4, the fifth transistor Q5, the sixth transistor Q6, the seventh transistor Q7, the eighth transistor Q8, the ninth transistor Q9, the tenth transistor Q10, the eleventh transistor Q11, and the twelfth transistor Q12 are metal-oxide-semiconductor field-effect transistors (MOSFETs), the control terminal of the first transistor Q1, the control terminal of the second transistor Q2, the control terminal of the third transistor Q3, the control terminal of the fourth transistor Q4, the control terminal of the fifth transistor Q5, the control terminal of the sixth transistor Q6, the control terminal of the seventh transistor Q7, the control terminal of the eighth transistor Q8, the control terminal of the ninth transistor Q9, the control terminal of the tenth transistor Q10, the control terminal of the eleventh transistor Q11, and the control terminal of the twelfth transistor Q12 refer to the gate of the MOSFET; the first terminal of the first transistor Q1, the first terminal of the second transistor Q2, the first terminal of the third transistor Q3, the first terminal of the fourth transistor Q4, the first terminal of the fifth transistor Q5, the first terminal of the sixth transistor Q6, the first terminal of the seventh transistor Q7, the first terminal of the eighth transistor Q8, the first terminal of the ninth transistor Q9, the first terminal of the tenth transistor Q10, the first terminal of the eleventh transistor Q11, and the first terminal of the twelfth transistor Q12 may be the drain or source of the MOSFET; and correspondingly, the second terminal of the first transistor Q1, the second terminal of the second transistor Q2, the second terminal of the third transistor Q3, the second terminal of the fourth transistor Q4, the second terminal of the fifth transistor Q5, the second terminal of the sixth transistor Q6, the second terminal of the seventh transistor Q7, the second terminal of the eighth transistor Q8, the second terminal of the ninth transistor Q9, the second terminal of the tenth transistor Q10, the second terminal of the eleventh transistor Q11, and the second terminal of the twelfth transistor Q12 may be the source or drain of the MOSFET.

For example, in a case where the first transistor Q1, the second transistor Q2, the third transistor Q3, the fourth transistor Q4, the fifth transistor Q5, the sixth transistor Q6, the seventh transistor Q7, the eighth transistor Q8, the ninth transistor Q9, the tenth transistor Q10, the eleventh transistor Q11, and the twelfth transistor Q12 are field-controlled thyristors, the control terminal of the first transistor Q1, the control terminal of the second transistor Q2, the control terminal of the third transistor Q3, the control terminal of the fourth transistor Q4, the control terminal of the fifth transistor Q5, the control terminal of the sixth transistor Q6, the control terminal of the seventh transistor Q7, the control terminal of the eighth transistor Q8, the control terminal of the ninth transistor Q9, the control terminal of the tenth transistor Q10, the control terminal of the eleventh transistor Q11, and the control terminal of the twelfth transistor Q12 refer to the gate of the field-controlled thyristor; the first terminal of the first transistor Q1, the first terminal of the second transistor Q2, the first terminal of the third transistor Q3, the first terminal of the fourth transistor Q4, the first terminal of the fifth transistor Q5, the first terminal of the sixth transistor Q6, the first terminal of the seventh transistor Q7, the first terminal of the eighth transistor Q8, the first terminal of the ninth transistor Q9, the first terminal of the tenth transistor Q10, the first terminal of the eleventh transistor Q11, and the first terminal of the twelfth transistor Q12 may be the drain or source of the field-controlled thyristor; and correspondingly, the second terminal of the first transistor Q1, the second terminal of the second transistor Q2, the second terminal of the third transistor Q3, the second terminal of the fourth transistor Q4, the second terminal of the fifth transistor Q5, the second terminal of the sixth transistor Q6, the second terminal of the seventh transistor Q7, the second terminal of the eighth transistor Q8, the second terminal of the ninth transistor Q9, the second terminal of the tenth transistor Q10, the second terminal of the eleventh transistor Q11, and the second terminal of the twelfth transistor Q12 may be the source or drain of the field-controlled thyristor.

For example, in the embodiment illustrated in FIG. 2, the first terminal of each of the transistors is a drain, the second terminal of each of the transistors is a source, and the control terminal of each of the transistors is a gate.

As illustrated in FIG. 2, the first terminal of the first transistor Q1 serves as the input terminal of the voltage conversion circuit 100. The first output terminal of the voltage conversion circuit 100 is disposed between the second terminal of the third transistor Q3 and the first terminal of the sixth transistor Q6. The second output terminal of the voltage conversion circuit 100 is disposed between the second terminal of the seventh transistor Q7 and the second terminal of the tenth transistor Q10.

The second plate of the first flying capacitor CF1 is electrically connected to the first plate of the second flying capacitor CF2 via the fourth transistor Q4. The second plate of the first flying capacitor CF1 is also electrically connected to the second plate of the second flying capacitor CF2 via the fourth transistor Q4, the seventh transistor Q7, and the eighth transistor Q8. Thus, by controlling the respective on/off states of the fourth transistor Q4, the seventh transistor Q7, and the eighth transistor Q8, the connection between the first flying capacitor CF1 and the second flying capacitor CF2 may be configured as series or parallel.

The first plate of the first flying capacitor CF1 is electrically connected to the first plate of the third flying capacitor CF3 via the third transistor Q3 and the sixth transistor Q6. The first plate of the first flying capacitor CF1 is also electrically connected to the second plate of the third flying capacitor CF3 via the third transistor Q3, the sixth transistor Q6, the tenth transistor Q10, and the eleventh transistor Q11. Thus, by controlling the respective on/off states of the third transistor Q3, the sixth transistor Q6, the tenth transistor Q10, and the eleventh transistor Q11, the connection between the first flying capacitor CF1 and the third flying capacitor CF3 may be configured as series or parallel.

The first plate of the second flying capacitor CF2 is electrically connected to the first plate of the third flying capacitor CF3 via the fifth transistor Q5, the third transistor Q3, and the sixth transistor Q6. The first plate of the second flying capacitor CF2 is also electrically connected to the second plate of the third flying capacitor CF3 via the seventh transistor Q7 and the eleventh transistor Q11. Thus, by controlling the respective on/off states of the fifth transistor Q5, the third transistor Q3, the sixth transistor Q6, the seventh transistor Q7, and the eleventh transistor Q11, the connection between the second flying capacitor CF2 and the third flying capacitor CF3 can be configured as series or parallel.

For example, in a case where the first transistor Q1, the fourth transistor Q4, the eighth transistor Q8, the tenth transistor Q10, and the twelfth transistor Q12 are all turned on, and the second transistor Q2, the third transistor Q3, the fifth transistor Q5, the sixth transistor Q6, the seventh transistor Q7, the ninth transistor Q9, and the eleventh transistor Q11 are all turned off, the first flying capacitor CF1 and the second flying capacitor CF2 are connected in series, and the series-connected first flying capacitor CF1 and second flying capacitor CF2 are then connected in parallel with the third flying capacitor CF3.

In summary, by controlling the on/off state of each transistor in the plurality of transistors 110, the connection relationships among the first flying capacitor CF1, the second flying capacitor CF2, and the third flying capacitor CF3 may be controlled. Thus, by controlling the connection relationships among the first flying capacitor CF1, the second flying capacitor CF2, and the third flying capacitor CF3, in a case where the input voltage VIN is input to the input terminal of the voltage conversion circuit 100, the voltage conversion circuit 100 may convert the input voltage VIN into the first output voltage VO1 and the second output voltage VO2 using only three flying capacitors. Consequently, the switched-capacitor converter 1000 may convert the input voltage VIN into the first output voltage VO1 and the second output voltage VO2.

The plurality of transistors 110 include a total of 12 transistors, which reduces the quantity of transistors in the switched-capacitor converter 1000, and thus significantly reduces the total quantity of components in the switched-capacitor converter 1000. Therefore, the area occupied by the switched-capacitor converter may be significantly reduced, which is more conducive to miniaturization of the switched-capacitor converter. At the same time, because the quantity of components in the switched-capacitor converter is significantly reduced, the connection relationships among the components are greatly simplified, leading to a significant reduction in the cost of the switched-capacitor converter.

In the switched-capacitor converter according to the present disclosure, the logic control circuit may control turn-on or turn-off of the plurality of transistors to change the connections among the first flying capacitor, the second flying capacitor, and the third flying capacitor, such that the voltage conversion circuit converts the input voltage into the first output voltage and the second output voltage. Thus, the switched-capacitor converter may convert the input voltage into the first output voltage and the second output voltage. In this way, the switched-capacitor converter may convert the input voltage into the first output voltage and the second output voltage using only three flying capacitors, which reduces the quantity of flying capacitors and transistors in the switched-capacitor converter, thereby reducing the total quantity of components. Therefore, the area occupied by the switched-capacitor converter is be reduced, which is conducive to miniaturization for the switched-capacitor converter. At the same time, because the quantity of components in the switched-capacitor converter is reduced, the connections among the components are simplified, lowering the cost of the switched-capacitor converter.

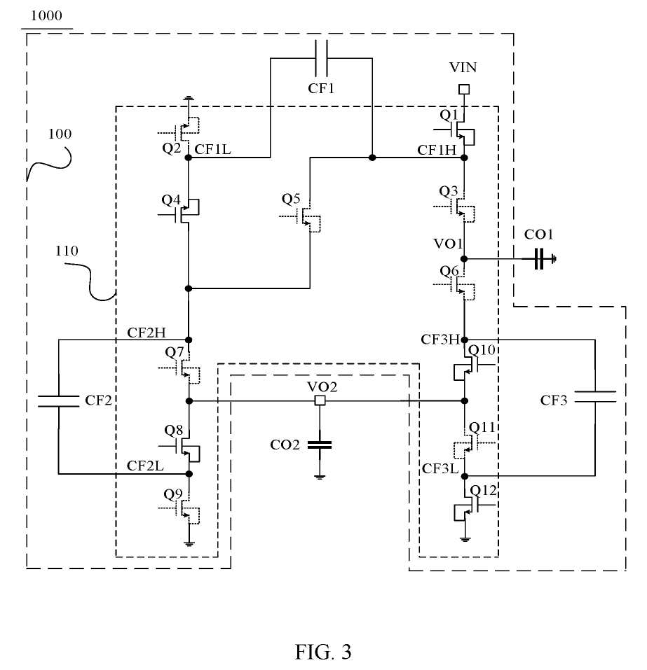

The specific implementation of the switched-capacitor converter 1000 in a first operating mode is described in detail with reference to FIGS. 3 to 6.

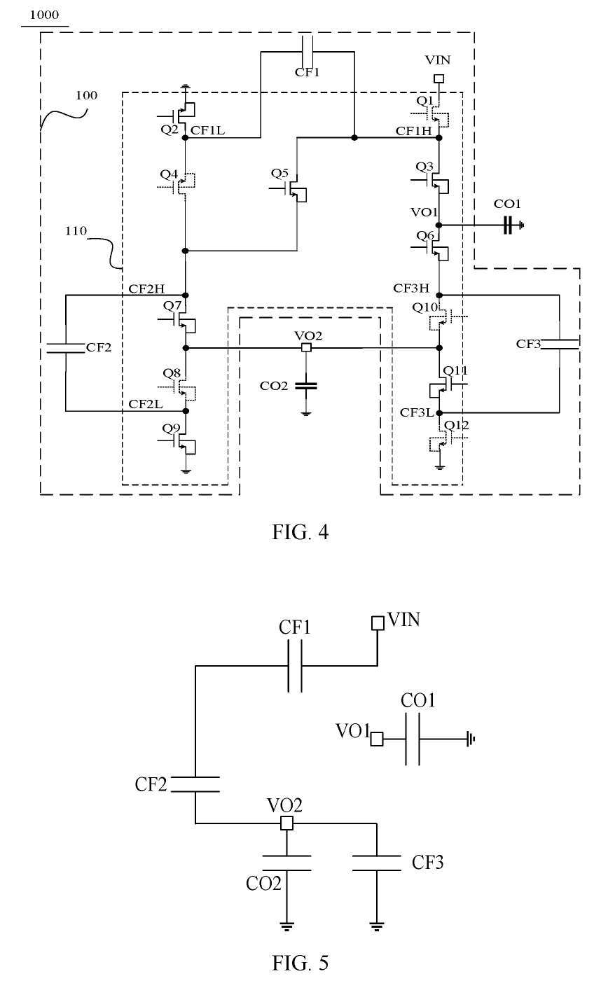

Referring to FIG. 3 and FIG. 4, FIG. 3 is a schematic structural diagram of a switched-capacitor converter in a first operating mode according to some embodiments of the present disclosure; and FIG. 4 is a schematic structural diagram of another switched-capacitor converter in the first operating mode according to some embodiments of the present disclosure. As illustrated in FIG. 3 and FIG. 4, in the first operating mode, the transistors in the plurality of transistors 110, except for the fifth transistor Q5, switch between a first phase and a second phase, such that a voltage conversion ratio among the input voltage VIN, the first output voltage VO1, and the second output voltage VO2 is 4:2:1.

In the first phase and the second phase, the fifth transistor Q5 is turned off; that is, the fifth transistor Q5 is always in a turned-off state.

As illustrated in FIG. 3, in the first phase, the first transistor Q1, the fourth transistor Q4, the eighth transistor Q8, the tenth transistor Q10, and the twelfth transistor Q12 are all turned on; and the second transistor Q2, the third transistor Q3, the sixth transistor Q6, the seventh transistor Q7, the ninth transistor Q9, and the eleventh transistor Q11 are all turned off.

As illustrated in FIG. 4, in the second phase, the first transistor Q1, the fourth transistor Q4, the eighth transistor Q8, the tenth transistor Q10, and the twelfth transistor Q12 are all turned off; and the second transistor Q2, the third transistor Q3, the sixth transistor Q6, the seventh transistor Q7, the ninth transistor Q9, and the eleventh transistor Q11 are all turned on.

For example, as illustrated in FIG. 3, in the first phase, in a case where the first transistor Q1 is turned on and the third transistor Q3 is turned off, the first plate of the first flying capacitor CF1 and the input terminal of the switched-capacitor converter 1000 are in a conduction state, and the first plate of the first flying capacitor CF1 and the first output terminal of the switched-capacitor converter 1000 are in a non-conduction state. In a case where the fourth transistor Q4 is turned on and the seventh transistor Q7 is turned off, the second plate of the first flying capacitor CF1 and the first plate of the second flying capacitor CF2 are in the conduction state, and the second plate of the first flying capacitor CF1 and the second output terminal of the switched-capacitor converter 1000 are in the non-conduction state. In a case where the eighth transistor Q8 is turned on and the ninth transistor Q9 is turned off, the second plate of the second flying capacitor CF2 and the second output terminal of the switched-capacitor converter 1000 are in the conduction state, and the second plate of the second flying capacitor CF2 and the ground terminal of the switched-capacitor converter 1000 are in the non-conduction state. In a case where the sixth transistor Q6 is turned off and the tenth transistor Q10 is turned on, the first plate of the third flying capacitor CF3 and the second output terminal of the switched-capacitor converter 1000 are in the conduction state, and the first plate of the third flying capacitor CF3 and the first output terminal of the switched-capacitor converter 1000 are in the non-conduction state. In a case where the eleventh transistor Q11 is turned off and the twelfth transistor Q12 is turned on, the second plate of the third flying capacitor CF3 and the ground terminal of the switched-capacitor converter 1000 are in the conduction state, and the second plate of the third flying capacitor CF3 and the second output terminal of the switched-capacitor converter 1000 are in the non-conduction state.

Thus, in the first phase, an equivalent circuit of the switched-capacitor converter 1000 may be as illustrated in FIG. 5. The first flying capacitor CF1 and the second flying capacitor CF2 are connected in series between the input terminal of the switched-capacitor converter 1000 and the second output terminal of the switched-capacitor converter 1000, and the third flying capacitor CF3 is electrically connected between the second output terminal of the switched-capacitor converter 1000 and the ground terminal of the switched-capacitor converter 1000. That is, the first flying capacitor CF1 and the second flying capacitor CF2 are connected in series, and the series-connected first flying capacitor CF1 and second flying capacitor CF2 are connected in parallel with the third flying capacitor CF3.

For example, as illustrated in FIG. 4, in the second phase, in a case where the first transistor Q1 is turned off and the third transistor Q3 is turned on, the first plate of the first flying capacitor CF1 and the input terminal of the switched-capacitor converter 1000 are in a non-conduction state, and the first plate of the first flying capacitor CF1 and the first output terminal of the switched-capacitor converter 1000 are in a conduction state. In a case where the fourth transistor Q4 is turned off and the second transistor Q2 is turned on, the second plate of the first flying capacitor CF1 and the first plate of the second flying capacitor CF2 are in the non-conduction state, and the second plate of the first flying capacitor CF1 and the ground terminal of the switched-capacitor converter 1000 are in the conduction state. In a case where the eighth transistor Q8 is turned off and the ninth transistor Q9 is turned on, the second plate of the second flying capacitor CF2 and the second output terminal of the switched-capacitor converter 1000 are in the non-conduction state, and the second plate of the second flying capacitor CF2 and the ground terminal of the switched-capacitor converter 1000 are in the conduction state. In a case where the sixth transistor Q6 is turned on and the tenth transistor Q10 is turned off, the first plate of the third flying capacitor CF3 and the second output terminal of the switched-capacitor converter 1000 are in the non-conduction state, and the first plate of the third flying capacitor CF3 and the first output terminal of the switched-capacitor converter 1000 are in the conduction state. In a case where the eleventh transistor Q11 is turned on and the twelfth transistor Q12 is turned off, the second plate of the third flying capacitor CF3 and the ground terminal of the switched-capacitor converter 1000 are in the non-conduction state, and the second plate of the third flying capacitor CF3 and the second output terminal of the switched-capacitor converter 1000 are in the conduction state.

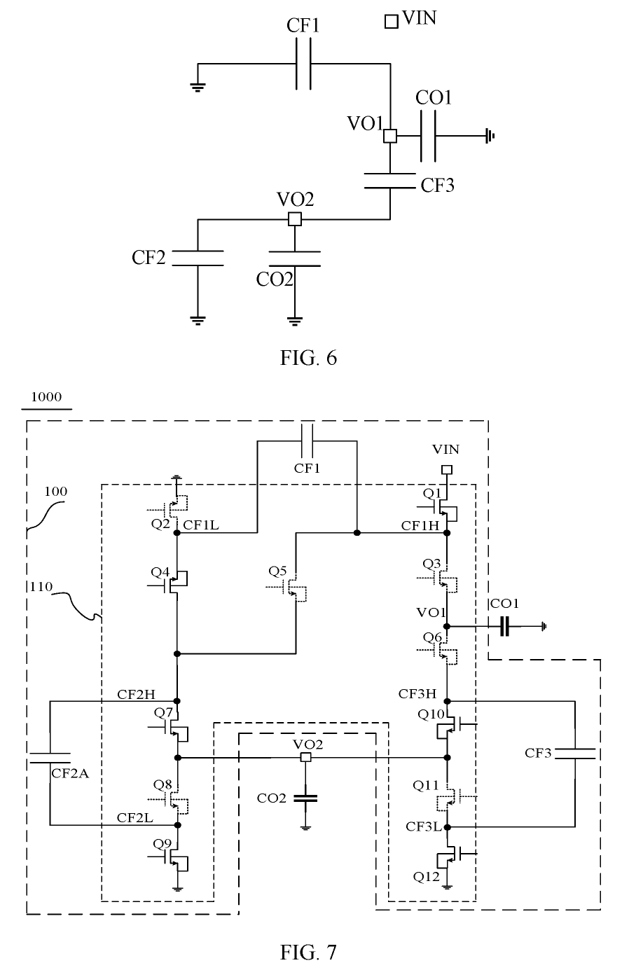

Thus, in the second phase, an equivalent circuit of the switched-capacitor converter 1000 may be as illustrated in FIG. 6. The first flying capacitor CF1 is electrically connected between the first output terminal of the switched-capacitor converter 1000 and the ground terminal of the switched-capacitor converter 1000, the second flying capacitor CF2 is electrically connected between the second output terminal of the switched-capacitor converter 1000 and the ground terminal of the switched-capacitor converter 1000, and the third flying capacitor CF3 is electrically connected between the first output terminal of the switched-capacitor converter 1000 and the second output terminal of the switched-capacitor converter 1000. That is, the third flying capacitor CF3 is connected in series to the second flying capacitor CF2, and the series-connected second flying capacitor CF2 and third flying capacitor CF3 are connected in parallel to the first flying capacitor CF1.

Therefore, in the first operating mode, the transistors in the plurality of transistors 110, except for the fifth transistor Q5, switch between the first phase and the second phase, such that the 4:2:1 voltage conversion is achieved among the input voltage VIN, the first output voltage VO1, and the second output voltage VO2.

The specific implementation of the switched-capacitor converter 1000 in a second operating mode is described in detail with reference to FIGS. 7 to 10.

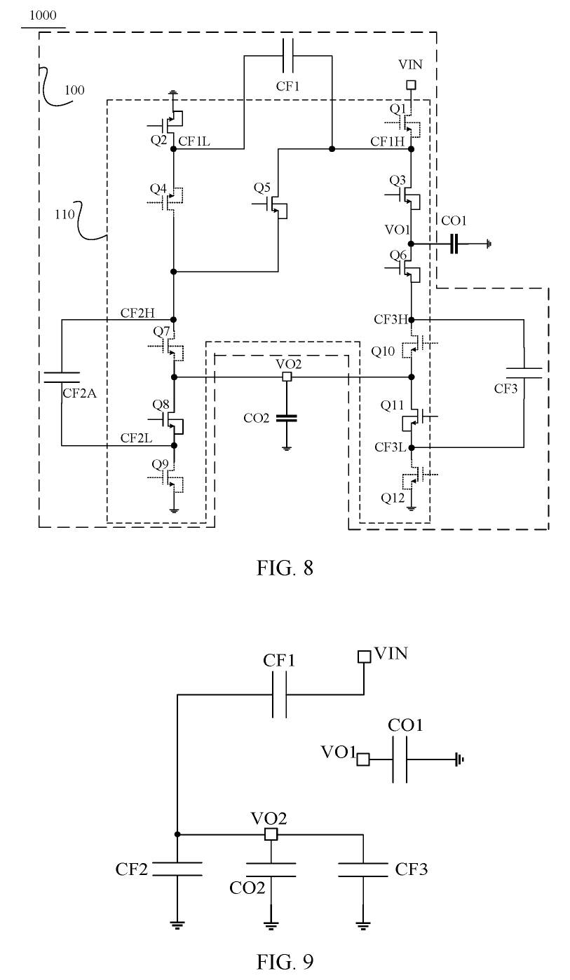

Referring to FIG. 7 and FIG. 8, FIG. 7 is a schematic structural diagram of a switched-capacitor converter in a second operating mode according to some embodiments of the present disclosure; and FIG. 8 is a schematic structural diagram of another switched-capacitor converter in the second operating mode according to some embodiments of the present disclosure. As illustrated in FIG. 7 and FIG. 8, in the second operating mode, the plurality of transistors 110 switch between a first phase and a second phase, such that a voltage conversion ratio among the input voltage VIN, the first output voltage VO1, and the second output voltage VO2 is 3:2:1.

As illustrated in FIG. 7, in the first phase, the first transistor Q1, the fourth transistor Q4, the seventh transistor Q7, the ninth transistor Q9, the tenth transistor Q10, and the twelfth transistor Q12 are all turned on; and the second transistor Q2, the third transistor Q3, the fifth transistor Q5, the sixth transistor Q6, the eighth transistor Q8, and the eleventh transistor Q11 are all turned off.

As illustrated in FIG. 8, in the second phase, the first transistor Q1, the fourth transistor Q4, the seventh transistor Q7, the ninth transistor Q9, the tenth transistor Q10, and the twelfth transistor Q12 are all turned off; and the second transistor Q2, the third transistor Q3, the fifth transistor Q5, the sixth transistor Q6, the eighth transistor Q8, and the eleventh transistor Q11 are all turned on.

For example, as illustrated in FIG. 7, in the first phase, in a case where the first transistor Q1 is turned on and the third transistor Q3 is turned off, the first plate of the first flying capacitor CF1 and the input terminal of the switched-capacitor converter 1000 are in a conduction state, and the first plate of the first flying capacitor CF1 and the first output terminal of the switched-capacitor converter 1000 are in a non-conduction state. In a case where the second transistor Q2 is turned off and the fourth transistor Q4 is turned on, the second plate of the first flying capacitor CF1 and the ground terminal of the switched-capacitor converter 1000 are in the non-conduction state, and the second plate of the first flying capacitor CF1 and the first plate of the second flying capacitor CF2 are in the conduction state. In a case where the fifth transistor Q5 is turned off and the first transistor Q1 and the seventh transistor Q7 are turned on, the first plate of the second flying capacitor CF2 and the input terminal of the switched-capacitor converter 1000 are in the non-conduction state, and the first plate of the second flying capacitor CF2 and the second output terminal of the switched-capacitor converter 1000 are in the conduction state. In a case where the eighth transistor Q8 is turned off and the ninth transistor Q9 is turned on, the second plate of the second flying capacitor CF2 and the second output terminal of the switched-capacitor converter 1000 are in the non-conduction state, and the second plate of the second flying capacitor CF2 and the ground terminal of the switched-capacitor converter 1000 are in the conduction state. In a case where the sixth transistor Q6 is turned off and the tenth transistor Q10 is turned on, the first plate of the third flying capacitor CF3 and the first output terminal of the switched-capacitor converter 1000 are in the non-conduction state, and the first plate of the third flying capacitor CF3 and the second output terminal of the switched-capacitor converter 1000 are in the conduction state. In a case where the eleventh transistor Q11 is turned off and the twelfth transistor Q12 is turned on, the second plate of the third flying capacitor CF3 and the second output terminal of the switched-capacitor converter 1000 are in the non-conduction state, and the second plate of the third flying capacitor CF3 and the ground terminal of the switched-capacitor converter 1000 are in the conduction state.

Thus, in the first phase, an equivalent circuit of the switched-capacitor converter 1000 may be as illustrated in FIG. 9. The first flying capacitor CF1 is electrically connected between the input terminal of the switched-capacitor converter 1000 and the second output terminal of the switched-capacitor converter 1000, and both the second flying capacitor CF2 and the third flying capacitor CF3 are electrically connected between the second output terminal of the switched-capacitor converter 1000 and the ground terminal of the switched-capacitor converter 1000. That is, the second flying capacitor CF2 is connected in parallel to the third flying capacitor CF3, and the parallel-connected second flying capacitor CF2 and third flying capacitor CF3 are connected in series to the first flying capacitor CF1.

For example, as illustrated in FIG. 8, in the second phase, in a case where the first transistor Q1 is turned off and the third transistor Q3 is turned on, the first plate of the first flying capacitor CF1 and the input terminal of the switched-capacitor converter 1000 are in a non-conduction state, and the first plate of the first flying capacitor CF1 and the first output terminal of the switched-capacitor converter 1000 are in a conduction state. In a case where the second transistor Q2 is turned on and the fourth transistor Q4 is turned off, the second plate of the first flying capacitor CF1 and the ground terminal of the switched-capacitor converter 1000 are in the conduction state, and the second plate of the first flying capacitor CF1 and the first plate of the second flying capacitor CF2 are in the non-conduction state. In a case where the fifth transistor Q5 is turned on and the first transistor Q1 and the seventh transistor Q7 are turned off, the first plate of the second flying capacitor CF2 and the first output terminal of the switched-capacitor converter 1000 are in the conduction state, and the first plate of the second flying capacitor CF2 and the second output terminal of the switched-capacitor converter 1000 are in the non-conduction state. In a case where the eighth transistor Q8 is turned on and the ninth transistor Q9 is turned off, the second plate of the second flying capacitor CF2 and the second output terminal of the switched-capacitor converter 1000 are in the conduction state, and the second plate of the second flying capacitor CF2 and the ground terminal of the switched-capacitor converter 1000 are in the non-conduction state. In a case where the sixth transistor Q6 is turned on and the tenth transistor Q10 is turned off, the first plate of the third flying capacitor CF3 and the first output terminal of the switched-capacitor converter 1000 are in the conduction state, and the first plate of the third flying capacitor CF3 and the second output terminal of the switched-capacitor converter 1000 are in the non-conduction state. In a case where the eleventh transistor Q11 is turned on and the twelfth transistor Q12 is turned off, the second plate of the third flying capacitor CF3 and the second output terminal of the switched-capacitor converter 1000 are in the conduction state, and the second plate of the third flying capacitor CF3 and the ground terminal of the switched-capacitor converter 1000 are in the non-conduction state.

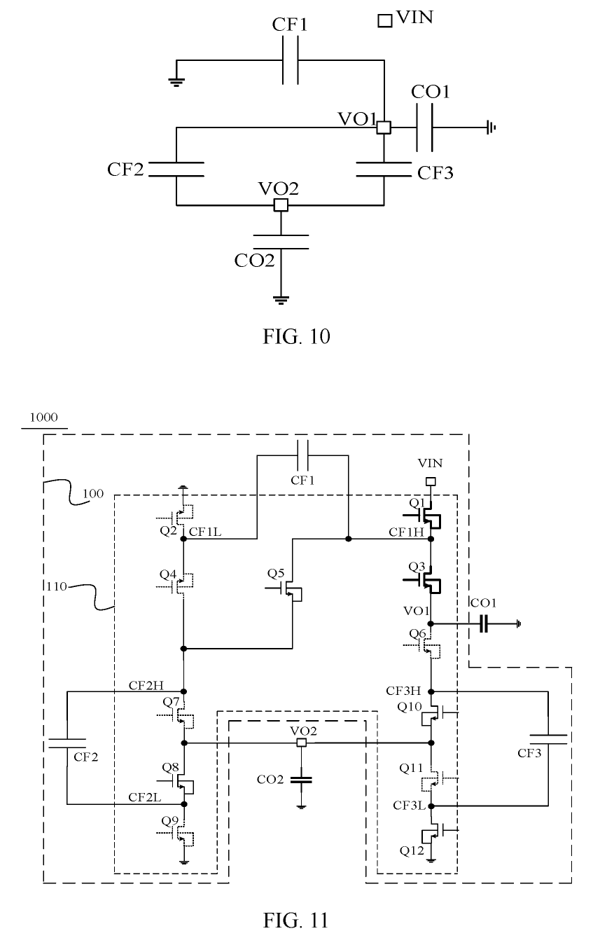

Thus, in the second phase, an equivalent circuit of the switched-capacitor converter 1000 may be as illustrated in FIG. 10, the first flying capacitor CF1 is electrically connected between the first output terminal of the switched-capacitor converter 1000 and the ground terminal of the switched-capacitor converter 1000, and both the second flying capacitor CF2 and the third flying capacitor CF3 are electrically connected between the first output terminal of the switched-capacitor converter 1000 and the second output terminal of the switched-capacitor converter 1000. That is, the third flying capacitor CF3 is connected in parallel to the second flying capacitor CF2, and the parallel-connected third flying capacitor CF3 and second flying capacitor CF2 are connected in series to the first flying capacitor CF1.

Therefore, in the second operating mode, the plurality of transistors 110 switch between the first phase and the second phase, such that 3:2:1 voltage conversion is achieved among the input voltage VIN, the first output voltage VO1, and the second output voltage VO2.

The specific implementation of the switched-capacitor converter 1000 in a third operating mode is described in detail with reference to FIGS. 11 to 14.

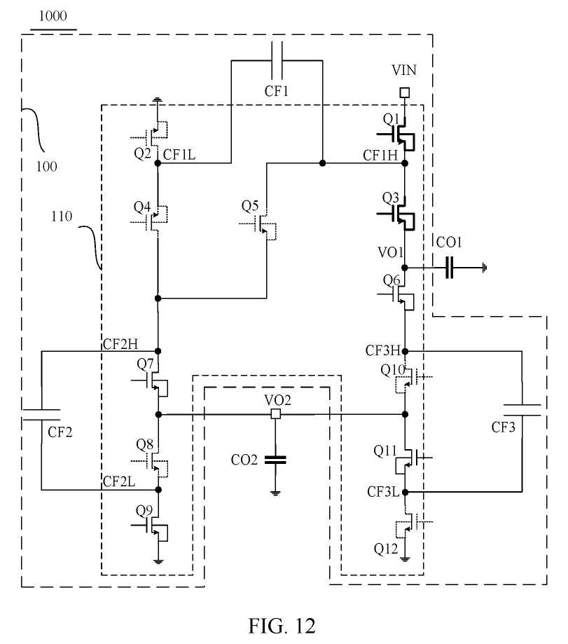

Referring to FIG. 11 and FIG. 12, FIG. 11 is a schematic structural diagram of a switched-capacitor converter in a third operating mode according to some embodiments of the present disclosure, and FIG. 12 is a schematic structural diagram of another switched-capacitor converter in the third operating mode according to some embodiments of the present disclosure. As illustrated in FIG. 11 and FIG. 12, in the third operating mode, the transistors in the plurality of transistors 110, except for the first transistor Q1, the second transistor Q2, the third transistor Q3, and the fourth transistor Q4, switch between a first phase and a second phase, such that a voltage conversion ratio among the input voltage VIN, the first output voltage VO1, and the second output voltage VO2 is 2:2:1.

In the first phase and the second phase, the first transistor Q1 and the third transistor Q3 are both turned on. That is, the first transistor Q1 and the third transistor Q3 are always in a turned-on state, such that the input terminal of the switched-capacitor converter 1000 and the first output terminal of the switched-capacitor converter 1000 are always in the conduction state. In the first phase and the second phase, the second transistor Q2 and the fourth transistor Q4 are both turned off., that is, the second transistor Q2 and the fourth transistor Q4 are always in a turned-off state, such that the first flying capacitor CF1 is disconnected from the switched-capacitor converter 1000.

As illustrated in FIG. 11, in the first phase, the fifth transistor Q5, the eighth transistor Q8, the tenth transistor Q10, and the twelfth transistor Q12 are all turned on; and the sixth transistor Q6, the seventh transistor Q7, the ninth transistor Q9, and the eleventh transistor Q11 are all turned off.

As illustrated in FIG. 12, in the second phase, the fifth transistor Q5, the eighth transistor Q8, the tenth transistor Q10, and the twelfth transistor Q12 are all turned off; and the sixth transistor Q6, the seventh transistor Q7, the ninth transistor Q9, and the eleventh transistor Q11 are all turned on.

For example, as illustrated in FIG. 11, in the first phase, in a case where the fifth transistor Q5 is turned on and the seventh transistor Q7 is turned off, the first plate of the second flying capacitor CF2 and the input terminal of the switched-capacitor converter 1000 are in the conduction state, and the first plate of the second flying capacitor CF2 and the second output terminal of the switched-capacitor converter 1000 are in the non-conduction state. In a case where the eighth transistor Q8 is turned on and the ninth transistor Q9 is turned off, the second plate of the second flying capacitor CF2 and the second output terminal of the switched-capacitor converter 1000 are in the conduction state, and the second plate of the second flying capacitor CF2 and the ground terminal of the switched-capacitor converter 1000 are in the non-conduction state. In a case where the sixth transistor Q6 is turned off and the tenth transistor Q10 is turned on, the first plate of the third flying capacitor CF3 and the first output terminal of the switched-capacitor converter 1000 are in the non-conduction state, and the first plate of the third flying capacitor CF3 and the second output terminal of the switched-capacitor converter 1000 are in the conduction state. In a case where the twelfth transistor Q12 is turned on and the eleventh transistor Q11 is turned off, the second plate of the third flying capacitor CF3 and the second output terminal of the switched-capacitor converter 1000 are in the non-conduction state, and the second plate of the third flying capacitor CF3 and the ground terminal of the switched-capacitor converter 1000 are in the conduction state.

Thus, in the first phase, an equivalent circuit of the switched-capacitor converter 1000 may be as illustrated in FIG. 13. The second flying capacitor CF2 is electrically connected between the input terminal of the switched-capacitor converter 1000 and the second output terminal of the switched-capacitor converter 1000, and the third flying capacitor CF3 is electrically connected between the second output terminal of the switched-capacitor converter 1000 and the ground terminal of the switched-capacitor converter 1000. That is, the second flying capacitor CF2 and the third flying capacitor CF3 are connected in series.

For example, as illustrated in FIG. 12, in a case where the fifth transistor Q5 is turned off and the seventh transistor Q7 is turned on, the first plate of the second flying capacitor CF2 and the input terminal of the switched-capacitor converter 1000 are in the non-conduction state, and the first plate of the second flying capacitor CF2 and the second output terminal of the switched-capacitor converter 1000 are in the conduction state. In a case where the eighth transistor Q8 is turned off and the ninth transistor Q9 is turned on, the second plate of the second flying capacitor CF2 and the second output terminal of the switched-capacitor converter 1000 are in the non-conduction state, and the second plate of the second flying capacitor CF2 and the ground terminal of the switched-capacitor converter 1000 are in the conduction state. In a case where the sixth transistor Q6 is turned on and the tenth transistor Q10 is turned off, the first plate of the third flying capacitor CF3 and the first output terminal of the switched-capacitor converter 1000 are in the conduction state, and the first plate of the third flying capacitor CF3 and the second output terminal of the switched-capacitor converter 1000 are in the non-conduction state. In a case where the twelfth transistor Q12 is turned off and the eleventh transistor Q11 is turned on, the second plate of the third flying capacitor CF3 and the second output terminal of the switched-capacitor converter 1000 are in the conduction state, and the second plate of the third flying capacitor CF3 and the ground terminal of the switched-capacitor converter 1000 are in the non-conduction state.

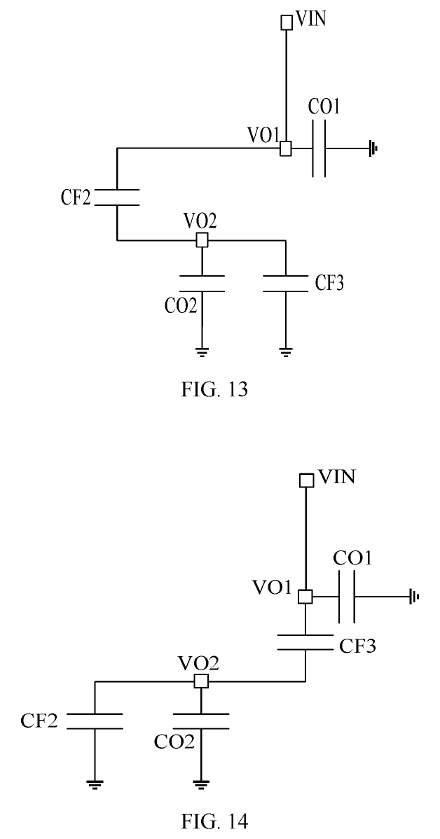

Thus, in the second phase, an equivalent circuit of the switched-capacitor converter 1000 may be as illustrated in FIG. 14. The second flying capacitor CF2 is electrically connected between the second output terminal of the switched-capacitor converter 1000 and the ground terminal of the switched-capacitor converter 1000, and the third flying capacitor CF3 is electrically connected between the input terminal of the switched-capacitor converter 1000 and the second output terminal of the switched-capacitor converter 1000. That is, the second flying capacitor CF2 and the third flying capacitor CF3 are connected in series.

Therefore, in the third operating mode, the transistors in the plurality of transistors 110, except for the first transistor Q1, the second transistor Q2, the third transistor Q3, and the fourth transistor Q4, switch between the first phase and the second phase, such that the 2:2:1 voltage conversion ratio is achieved among the input voltage VIN, the first output voltage VO1, and the second output voltage VO2.

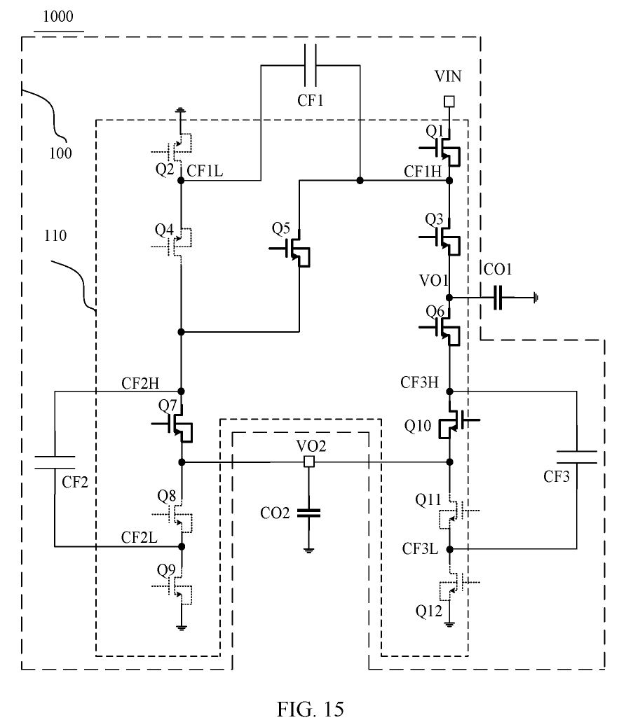

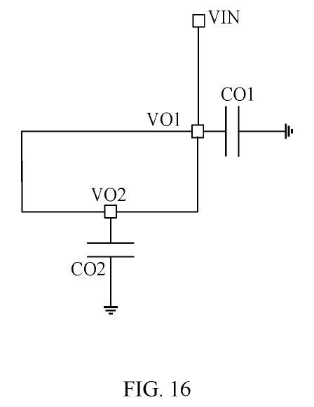

The specific implementation of the switched-capacitor converter 1000 in a fourth operating mode is described in detail with reference to FIGS. 15 and 16.

Referring to FIG. 15, FIG. 15 is a schematic structural diagram of a switched-capacitor converter in a fourth operating mode according to some embodiments of the present disclosure. As illustrated in FIG. 15, in the fourth operating mode, the first transistor Q1, the third transistor Q3, the fifth transistor Q5, the sixth transistor Q6, the seventh transistor Q7, and the tenth transistor Q10 are all turned on; and the second transistor Q2, the fourth transistor Q4, the eighth transistor Q8, the ninth transistor Q9, the eleventh transistor Q11, and the twelfth transistor Q12 are all turned off, such that a voltage conversion ratio among the input voltage VIN, the first output voltage VO1, and the second output voltage VO2 is 1:1:1.

For example, as illustrated in FIG. 15, in a case where the second transistor Q2 and the fourth transistor Q4 are turned off, the first flying capacitor CF1 is disconnected from the switched-capacitor converter 1000. In a case where the eighth transistor Q8 and the ninth transistor Q9 are turned off, the second flying capacitor CF2 is disconnected from the switched-capacitor converter 1000. In a case where the eleventh transistor Q11 and the twelfth transistor Q12 are turned off, the third flying capacitor CF3 is disconnected from the switched-capacitor converter 1000. In a case where the first transistor Q1 and the third transistor Q3 are turned on, the input terminal of the switched-capacitor converter 1000 and the first output terminal of the switched-capacitor converter 1000 are in the conduction state. In a case where the sixth transistor Q6 and the tenth transistor Q10 are turned on, the first output terminal of the switched-capacitor converter 1000 and the second output terminal of the switched-capacitor converter 1000 are in the conduction state. In a case where the fifth transistor Q5 and the seventh transistor Q7 are turned on, the input terminal of the switched-capacitor converter 1000 and the second output terminal of the switched-capacitor converter 1000 are in the conduction state.

Thus, in this operating mode, an equivalent circuit of the switched-capacitor converter 1000 may be as illustrated in FIG. 16. The first flying capacitor CF1, the second flying capacitor CF2, and the third flying capacitor CF3 are all disconnected from the switched-capacitor converter 1000. The first output terminal of the switched-capacitor converter 1000, the second output terminal of the switched-capacitor converter 1000, and the input terminal of the switched-capacitor converter 1000 all are in the conduction state.

Therefore, in the fourth operating mode, the 1:1:1 voltage conversion ratio may be achieved among the input voltage VIN, the first output voltage VO1, and the second output voltage VO2.

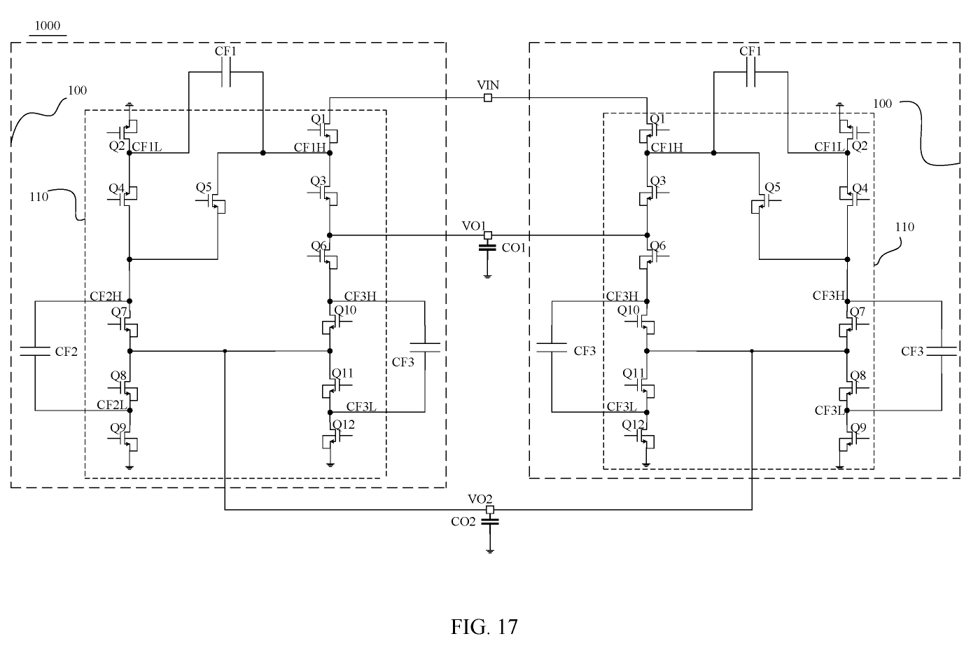

Based on the description of the above embodiments, a possible implementation of the voltage conversion circuit 100 is provided. Referring to FIG. 17, FIG. 17 is a schematic structural diagram of another switched-capacitor converter according to some embodiments of the present disclosure. As illustrated in FIG. 17, the quantity of the voltage conversion circuit 100 is at least two.

An input terminal of each of the voltage conversion circuits 100 is electrically connected to the input terminal of the switched-capacitor converter 1000, a first output terminal of each of the voltage conversion circuits 100 is electrically connected to the first output terminal of the switched-capacitor converter 1000, a second output terminal of each of the voltage conversion circuits 100 is electrically connected to the second output terminal of the switched-capacitor converter 1000, and the respective voltage conversion circuits 100 are connected in parallel.

By connecting at least two voltage conversion circuits 100 in parallel, the at least two voltage conversion circuits 100 may share the load current. Thus, the output currents of the at least two voltage conversion circuits 100 are summed, such that the output current of the switched-capacitor converter 1000 is increased. Consequently, the switched-capacitor converter 1000 may achieve a higher power output. At the same time, the at least two parallel-connected voltage conversion circuits may share the load current. In a case where the load changes, the at least two voltage conversion circuits work together, such that the at least two voltage conversion circuits supply the output current more stably. Therefore, the switched-capacitor converter 1000 may output an output voltage with smaller ripples.

Based on the description of the above embodiments, a possible implementation of the switched-capacitor converter 1000 is provided. As illustrated in FIGS. 3 to 17, the switched-capacitor converter 1000 may further include a first output capacitor CO1 and a second output capacitor CO2.

A first plate of the first output capacitor CO1 is electrically connected to the first output terminal of the switched-capacitor converter 1000, a first plate of the second output capacitor CO2 is electrically connected to the second output terminal of the switched-capacitor converter 1000, and a second plate of the first output capacitor CO1 and a second plate of the second output capacitor CO2 are both connected to ground.

The first output capacitor CO1 and the second output capacitor CO2 may be referred to as output filter capacitors. In this way, the first output capacitor CO1 may smooth and filter high-frequency noise and ripples in the first output voltage VO1, such that the first output voltage VO1 is prevented from the effects of high-frequency noise and ripples. Consequently, the switched-capacitor converter 1000 may output a more stable first output voltage VO1. The second output capacitor CO2 may smooth and filter high-frequency noise and ripples in the second output voltage VO2, such that the second output voltage VO2 is prevented from the effects of high-frequency noise and ripples. Consequently, the switched-capacitor converter 1000 may output a more stable second output voltage VO2.

Some embodiments of the present disclosure further provide a switched-capacitor converter chip. The chip includes the switched-capacitor converter according to the embodiments of the present disclosure.

The switched-capacitor converter chip herein achieves the same technical effects as the switched-capacitor converter according to the embodiments of the present disclosure, which are not described herein any further.

Some embodiments of the present disclosure further provide an electronic device. The electronic device includes the switched-capacitor converter chip as described above.

The electronic device herein achieves the same technical effects as the switched-capacitor converter chip according to the embodiments of the present disclosure, which are not described herein any further.

It should be finally noted that the above embodiments are used only for illustrating the present disclosure, but are not intended to limit the protection scope of the present disclosure. Various modifications and replacements readily derived by those skilled in the art within technical content of the present disclosure shall fall within the protection scope of the present disclosure. Therefore, the protection scope of the present disclosure is subject to the appended claims.

What is claimed is:

1. A switched-capacitor converter, comprising: a voltage conversion circuit; wherein an input terminal of the voltage conversion circuit is electrically connected to an input terminal of the switched-capacitor converter, a first output terminal of the voltage conversion circuit is electrically connected to a first output terminal of the switched-capacitor converter, and a second output terminal of the voltage conversion circuit is electrically connected to a second output terminal of the switched-capacitor converter; and the voltage conversion circuit comprises a plurality of transistors, a logic control circuit, a first flying capacitor, a second flying capacitor, and a third flying capacitor, wherein control terminals of the plurality of transistors are all electrically connected to the logic control circuit, and wherein a quantity of each of the first flying capacitor, the second flying capacitor, and the third flying capacitor is one;
wherein the plurality of transistors comprise a first transistor, a second transistor, a third transistor, a fourth transistor, a fifth transistor, a sixth transistor, a seventh transistor, an eighth transistor, a ninth transistor, a tenth transistor, an eleventh transistor, and a twelfth transistor;
wherein
a first terminal of the first transistor is electrically connected to the input terminal of the switched-capacitor converter, a second terminal of the first transistor is electrically connected to a first terminal of the third transistor, a second terminal of the third transistor is electrically connected to a first terminal of the sixth transistor, a second terminal of the sixth transistor is electrically connected to a first terminal of the tenth transistor, a second terminal of the tenth transistor is electrically connected to a first terminal of the eleventh transistor, and a second terminal of the eleventh transistor is electrically connected to a first terminal of the twelfth transistor;
a first terminal of the second transistor is electrically connected to a second terminal of the fourth transistor, a first terminal of the fourth transistor is electrically connected to a first terminal of the seventh transistor, a second terminal of the seventh transistor is electrically connected to a first terminal of the eighth transistor, and a second terminal of the eighth transistor is electrically connected to a first terminal of the ninth transistor;
a first plate of the first flying capacitor and a first terminal of the fifth transistor are both electrically connected between the second terminal of the first transistor and the first terminal of the third transistor, a second plate of the first flying capacitor is electrically connected between the first terminal of the second transistor and the second terminal of the fourth transistor, a second terminal of the fifth transistor and a first plate of the second flying capacitor are both electrically connected between the first terminal of the fourth transistor and the first terminal of the seventh transistor, and a second plate of the second flying capacitor is electrically connected between the second terminal of the eighth transistor and the first terminal of the ninth transistor;
a first plate of the third flying capacitor is electrically connected between the second terminal of the sixth transistor and the first terminal of the tenth transistor, and a second plate of the third flying capacitor is electrically connected between the second terminal of the eleventh transistor and the first terminal of the twelfth transistor;
the first output terminal of the switched-capacitor converter is electrically connected between the second terminal of the third transistor and the first terminal of the sixth transistor, the second terminal of the seventh transistor and the second terminal of the tenth transistor are further electrically connected to the second output terminal of the switched-capacitor converter, and a second terminal of the second transistor, a second terminal of the ninth transistor, and a second terminal of the twelfth transistor are all electrically connected to a ground terminal of the switched-capacitor converter; and
the logic control circuit is configured to control turn-on or turn-off of the first transistor, the second transistor, the third transistor, the fourth transistor, the fifth transistor, the sixth transistor, the seventh transistor, the eighth transistor, the ninth transistor, the tenth transistor, the eleventh transistor, and the twelfth transistor, to change connections among the first flying capacitor, the second flying capacitor, and the third flying capacitor, such that the switched-capacitor converter converts an input voltage into a first output voltage and a second output voltage, wherein the input voltage is a voltage at the input terminal of the switched-capacitor converter, the first output voltage is a voltage at the first output terminal of the switched-capacitor converter, and the second output voltage is a voltage at the second output terminal of the switched-capacitor converter.

2. The switched-capacitor converter according to claim 1, wherein in a first operating mode, a voltage conversion ratio among the input voltage, the first output voltage, and the second output voltage is 4-2.:1, wherein the first operating mode is a mode in which the plurality of transistors, except for the fifth transistor, switch between a first phase and a second phase; wherein
in the first phase and the second phase, the fifth transistor is turned off;
in the first phase, the first transistor, the fourth transistor, the eighth transistor, the tenth transistor, and the twelfth transistor are all turned on; and the second transistor, the third transistor, the sixth transistor, the seventh transistor, the ninth transistor, and the eleventh transistor are all turned off; and
in the second phase, the first transistor, the fourth transistor, the eighth transistor, the tenth transistor, and the twelfth transistor are all turned off; and the second transistor, the third transistor, the sixth transistor, the seventh transistor, the ninth transistor, and the eleventh transistor are all turned on.

3. The switched-capacitor converter according to claim 1, wherein
in a second operating mode, a voltage conversion ratio among the input voltage, the first output voltage, and the second output voltage is 3-2.:1, wherein the second operating mode is a mode in which the plurality of transistors switch between a first phase and a second phase; wherein
in the first phase, the first transistor, the fourth transistor, the seventh transistor, the ninth transistor, the tenth transistor, and the twelfth transistor are all turned on; and the second transistor, the third transistor, the fifth transistor, the sixth transistor, the eighth transistor, and the eleventh transistor are all turned off; and
in the second phase, the first transistor, the fourth transistor, the seventh transistor, the ninth transistor, the tenth transistor, and the twelfth transistor are all turned off; and the second transistor, the third transistor, the fifth transistor, the sixth transistor, the eighth transistor, and the eleventh transistor are all turned on.

4. The switched-capacitor converter according to claim 1, wherein
in a third operating mode, a voltage conversion ratio among the input voltage, the first output voltage, and the second output voltage is 2-2.:1, wherein the third operating mode is a mode in which the plurality of transistors, except for the first transistor, the second transistor, the third transistor, and the fourth transistor, switch between a first phase and a second phase;
wherein
in the first phase and the second phase, the first transistor and the third transistor are both turned on, and the second transistor and the fourth transistor are both turned off;
in the first phase, the fifth transistor, the eighth transistor, the tenth transistor, and the twelfth transistor are all turned on; and the sixth transistor, the seventh transistor, the ninth transistor, and the eleventh transistor are all turned off; and
in the second phase, the fifth transistor, the eighth transistor, the tenth transistor, and the twelfth transistor are all turned off; and the sixth transistor, the seventh transistor, the ninth transistor, and the eleventh transistor are all turned on.

5. The switched-capacitor converter according to claim 1, wherein in a fourth operating mode, a voltage conversion ratio among the input voltage, the first output voltage, and the second output voltage is 1-1.:1;
wherein in the fourth operating mode, the first transistor, the third transistor, the fifth transistor, the sixth transistor, the seventh transistor, and the tenth transistor are all turned on; and the second transistor, the fourth transistor, the eighth transistor, the ninth transistor, the eleventh transistor, and the twelfth transistor are all turned off.

6. The switched-capacitor converter according to claim 1, wherein a quantity of the voltage conversion circuit is at least two; wherein an input terminal of each of the voltage conversion circuits is electrically connected to the input terminal of the switched-capacitor converter, a first output terminal of each of the voltage conversion circuits is electrically connected to the first output terminal of the switched-capacitor converter, a second output terminal of each of the voltage conversion circuits is electrically connected to the second output terminal of the switched-capacitor converter, and the respective voltage conversion circuits are connected in parallel.

7. The switched-capacitor converter according to claim 1, further comprising: a first output capacitor and a second output capacitor;
wherein a first plate of the first output capacitor is electrically connected to the first output terminal of the switched-capacitor converter, a first plate of the second output capacitor is electrically connected to the second output terminal of the switched-capacitor converter, and a second plate of the first output capacitor and a second plate of the second output capacitor are both electrically connected to the ground terminal of the switched-capacitor converter.

8. The switched-capacitor converter according to claim 1, wherein the first terminals of the first transistor, the second transistor, the third transistor, the fourth transistor, the fifth transistor, the sixth transistor, the seventh transistor, the eighth transistor, the ninth transistor, the tenth transistor, the eleventh transistor, and the twelfth transistor are all drains; the second terminals of the first transistor, the second transistor, the third transistor, the fourth transistor, the fifth transistor, the sixth transistor, the seventh transistor, the eighth transistor, the ninth transistor, the tenth transistor, the eleventh transistor, and the twelfth transistor are all sources; and the control terminals of the first transistor, the second transistor, the third transistor, the fourth transistor, the fifth transistor, the sixth transistor, the seventh transistor, the eighth transistor, the ninth transistor, the tenth transistor, the eleventh transistor, and the twelfth transistor are all gates.

9. A chip, comprising a switched-capacitor converter, wherein the switched-capacitor converter comprises a voltage conversion circuit; wherein,
an input terminal of the voltage conversion circuit is electrically connected to an input terminal of the switched-capacitor converter, a first output terminal of the voltage conversion circuit is electrically connected to a first output terminal of the switched-capacitor converter, and a second output terminal of the voltage conversion circuit is electrically connected to a second output terminal of the switched-capacitor converter; and the voltage conversion circuit comprises a plurality of transistors, a logic control circuit, a first flying capacitor, a second flying capacitor, and a third flying capacitor, wherein control terminals of the plurality of transistors are all electrically connected to the logic control circuit, and wherein a quantity of each of the first flying capacitor, the second flying capacitor, and the third flying capacitor is one;
wherein the plurality of transistors comprise a first transistor, a second transistor, a third transistor, a fourth transistor, a fifth transistor, a sixth transistor, a seventh transistor, an eighth transistor, a ninth transistor, a tenth transistor, an eleventh transistor, and a twelfth transistor;
wherein
a first terminal of the first transistor is electrically connected to the input terminal of the switched-capacitor converter, a second terminal of the first transistor is electrically connected to a first terminal of the third transistor, a second terminal of the third transistor is electrically connected to a first terminal of the sixth transistor, a second terminal of the sixth transistor is electrically connected to a first terminal of the tenth transistor, a second terminal of the tenth transistor is electrically connected to a first terminal of the eleventh transistor, and a second terminal of the eleventh transistor is electrically connected to a first terminal of the twelfth transistor;
a first terminal of the second transistor is electrically connected to a second terminal of the fourth transistor, a first terminal of the fourth transistor is electrically connected to a first terminal of the seventh transistor, a second terminal of the seventh transistor is electrically connected to a first terminal of the eighth transistor, and a second terminal of the eighth transistor is electrically connected to a first terminal of the ninth transistor;
a first plate of the first flying capacitor and a first terminal of the fifth transistor are both electrically connected between the second terminal of the first transistor and the first terminal of the third transistor, a second plate of the first flying capacitor is electrically connected between the first terminal of the second transistor and the second terminal of the fourth transistor, a second terminal of the fifth transistor and a first plate of the second flying capacitor are both electrically connected between the first terminal of the fourth transistor and the first terminal of the seventh transistor, and a second plate of the second flying capacitor is electrically connected between the second terminal of the eighth transistor and the first terminal of the ninth transistor;
a first plate of the third flying capacitor is electrically connected between the second terminal of the sixth transistor and the first terminal of the tenth transistor, and a second plate of the third flying capacitor is electrically connected between the second terminal of the eleventh transistor and the first terminal of the twelfth transistor;
the first output terminal of the switched-capacitor converter is electrically connected between the second terminal of the third transistor and the first terminal of the sixth transistor, the second terminal of the seventh transistor and the second terminal of the tenth transistor are further electrically connected to the second output terminal of the switched-capacitor converter, and a second terminal of the second transistor, a second terminal of the ninth transistor, and a second terminal of the twelfth transistor are all electrically connected to a ground terminal of the switched-capacitor converter; and
the logic control circuit is configured to control turn-on or turn-off of the first transistor, the second transistor, the third transistor, the fourth transistor, the fifth transistor, the sixth transistor, the seventh transistor, the eighth transistor, the ninth transistor, the tenth transistor, the eleventh transistor, and the twelfth transistor, to change connections among the first flying capacitor, the second flying capacitor, and the third flying capacitor, such that the switched-capacitor converter converts an input voltage into a first output voltage and a second output voltage, wherein the input voltage is a voltage at the input terminal of the switched-capacitor converter, the first output voltage is a voltage at the first output terminal of the switched-capacitor converter, and the second output voltage is a voltage at the second output terminal of the switched-capacitor converter.

10. The chip according to claim 9, wherein in a first operating mode, a voltage conversion ratio among the input voltage, the first output voltage, and the second output voltage is 4:2:1, wherein the first operating mode is a mode in which the plurality of transistors, except for the fifth transistor, switch between a first phase and a second phase; wherein
in the first phase and the second phase, the fifth transistor is turned off;
in the first phase, the first transistor, the fourth transistor, the eighth transistor, the tenth transistor, and the twelfth transistor are all turned on; and the second transistor, the third transistor, the sixth transistor, the seventh transistor, the ninth transistor, and the eleventh transistor are all turned off; and
in the second phase, the first transistor, the fourth transistor, the eighth transistor, the tenth transistor, and the twelfth transistor are all turned off; and the second transistor, the third transistor, the sixth transistor, the seventh transistor, the ninth transistor, and the eleventh transistor are all turned on.

11. The chip according to claim 9, wherein
in a second operating mode, a voltage conversion ratio among the input voltage, the first output voltage, and the second output voltage is 3:2:1, wherein the second operating mode is a mode in which the plurality of transistors switch between a first phase and a second phase; wherein
in the first phase, the first transistor, the fourth transistor, the seventh transistor, the ninth transistor, the tenth transistor, and the twelfth transistor are all turned on; and the second transistor, the third transistor, the fifth transistor, the sixth transistor, the eighth transistor, and the eleventh transistor are all turned off; and
in the second phase, the first transistor, the fourth transistor, the seventh transistor, the ninth transistor, the tenth transistor, and the twelfth transistor are all turned off; and the second transistor, the third transistor, the fifth transistor, the sixth transistor, the eighth transistor, and the eleventh transistor are all turned on.

12. The chip according to claim 9, wherein
in a third operating mode, a voltage conversion ratio among the input voltage, the first output voltage, and the second output voltage is 2:2:1, wherein the third operating mode is a mode in which the plurality of transistors, except for the first transistor, the second transistor, the third transistor, and the fourth transistor, switch between a first phase and a second phase;
wherein
in the first phase and the second phase, the first transistor and the third transistor are both turned on, and the second transistor and the fourth transistor are both turned off;
in the first phase, the fifth transistor, the eighth transistor, the tenth transistor, and the twelfth transistor are all turned on; and the sixth transistor, the seventh transistor, the ninth transistor, and the eleventh transistor are all turned off; and
in the second phase, the fifth transistor, the eighth transistor, the tenth transistor, and the twelfth transistor are all turned off; and the sixth transistor, the seventh transistor, the ninth transistor, and the eleventh transistor are all turned on.

13. The chip according to claim 9, wherein in a fourth operating mode, a voltage conversion ratio among the input voltage, the first output voltage, and the second output voltage is 1:1:1;
wherein in the fourth operating mode, the first transistor, the third transistor, the fifth transistor, the sixth transistor, the seventh transistor, and the tenth transistor are all turned on; and the second transistor, the fourth transistor, the eighth transistor, the ninth transistor, the eleventh transistor, and the twelfth transistor are all turned off.

14. The chip according to claim 9, wherein a quantity of the voltage conversion circuit is at least two; wherein an input terminal of each of the voltage conversion circuits is electrically connected to the input terminal of the switched-capacitor converter, a first output terminal of each of the voltage conversion circuits is electrically connected to the first output terminal of the switched-capacitor converter, a second output terminal of each of the voltage conversion circuits is electrically connected to the second output terminal of the switched-capacitor converter, and the respective voltage conversion circuits are connected in parallel.

15. The chip according to claim 9, wherein the switched-capacitor converter further comprises: a first output capacitor and a second output capacitor;
wherein a first plate of the first output capacitor is electrically connected to the first output terminal of the switched-capacitor converter, a first plate of the second output capacitor is electrically connected to the second output terminal of the switched-capacitor converter, and a second plate of the first output capacitor and a second plate of the second output capacitor are both electrically connected to the ground terminal of the switched-capacitor converter.

16. The chip according to claim 9, wherein the first terminals of the first transistor, the second transistor, the third transistor, the fourth transistor, the fifth transistor, the sixth transistor, the seventh transistor, the eighth transistor, the ninth transistor, the tenth transistor, the eleventh transistor, and the twelfth transistor are all drains; the second terminals of the first transistor, the second transistor, the third transistor, the fourth transistor, the fifth transistor, the sixth transistor, the seventh transistor, the eighth transistor, the ninth transistor, the tenth transistor, the eleventh transistor, and the twelfth transistor are all sources; and the control terminals of the first transistor, the second transistor, the third transistor, the fourth transistor, the fifth transistor, the sixth transistor, the seventh transistor, the eighth transistor, the ninth transistor, the tenth transistor, the eleventh transistor, and the twelfth transistor are all gates.

17. An electronic device, comprising a switched-capacitor converter, wherein the switched-capacitor converter comprises a voltage conversion circuit; wherein,
an input terminal of the voltage conversion circuit is electrically connected to an input terminal of the switched-capacitor converter, a first output terminal of the voltage conversion circuit is electrically connected to a first output terminal of the switched-capacitor converter, and a second output terminal of the voltage conversion circuit is electrically connected to a second output terminal of the switched-capacitor converter; and the voltage conversion circuit comprises a plurality of transistors, a logic control circuit, a first flying capacitor, a second flying capacitor, and a third flying capacitor, wherein control terminals of the plurality of transistors are all electrically connected to the logic control circuit, and wherein a quantity of each of the first flying capacitor, the second flying capacitor, and the third flying capacitor is one;
wherein the plurality of transistors comprise a first transistor, a second transistor, a third transistor, a fourth transistor, a fifth transistor, a sixth transistor, a seventh transistor, an eighth transistor, a ninth transistor, a tenth transistor, an eleventh transistor, and a twelfth transistor;
wherein
a first terminal of the first transistor is electrically connected to the input terminal of the switched-capacitor converter, a second terminal of the first transistor is electrically connected to a first terminal of the third transistor, a second terminal of the third transistor is electrically connected to a first terminal of the sixth transistor, a second terminal of the sixth transistor is electrically connected to a first terminal of the tenth transistor, a second terminal of the tenth transistor is electrically connected to a first terminal of the eleventh transistor, and a second terminal of the eleventh transistor is electrically connected to a first terminal of the twelfth transistor;
a first terminal of the second transistor is electrically connected to a second terminal of the fourth transistor, a first terminal of the fourth transistor is electrically connected to a first terminal of the seventh transistor, a second terminal of the seventh transistor is electrically connected to a first terminal of the eighth transistor, and a second terminal of the eighth transistor is electrically connected to a first terminal of the ninth transistor;
a first plate of the first flying capacitor and a first terminal of the fifth transistor are both electrically connected between the second terminal of the first transistor and the first terminal of the third transistor, a second plate of the first flying capacitor is electrically connected between the first terminal of the second transistor and the second terminal of the fourth transistor, a second terminal of the fifth transistor and a first plate of the second flying capacitor are both electrically connected between the first terminal of the fourth transistor and the first terminal of the seventh transistor, and a second plate of the second flying capacitor is electrically connected between the second terminal of the eighth transistor and the first terminal of the ninth transistor;
a first plate of the third flying capacitor is electrically connected between the second terminal of the sixth transistor and the first terminal of the tenth transistor, and a second plate of the third flying capacitor is electrically connected between the second terminal of the eleventh transistor and the first terminal of the twelfth transistor;
the first output terminal of the switched-capacitor converter is electrically connected between the second terminal of the third transistor and the first terminal of the sixth transistor, the second terminal of the seventh transistor and the second terminal of the tenth transistor are further electrically connected to the second output terminal of the switched-capacitor converter, and a second terminal of the second transistor, a second terminal of the ninth transistor, and a second terminal of the twelfth transistor are all electrically connected to a ground terminal of the switched-capacitor converter; and
the logic control circuit is configured to control turn-on or turn-off of the first transistor, the second transistor, the third transistor, the fourth transistor, the fifth transistor, the sixth transistor, the seventh transistor, the eighth transistor, the ninth transistor, the tenth transistor, the eleventh transistor, and the twelfth transistor, to change connections among the first flying capacitor, the second flying capacitor, and the third flying capacitor, such that the switched-capacitor converter converts an input voltage into a first output voltage and a second output voltage, wherein the input voltage is a voltage at the input terminal of the switched-capacitor converter, the first output voltage is a voltage at the first output terminal of the switched-capacitor converter, and the second output voltage is a voltage at the second output terminal of the switched-capacitor converter.

18. The electronic device according to claim 17, wherein in a first operating mode, a voltage conversion ratio among the input voltage, the first output voltage, and the second output voltage is 4-2.:1, wherein the first operating mode is a mode in which the plurality of transistors, except for the fifth transistor, switch between a first phase and a second phase; wherein
in the first phase and the second phase, the fifth transistor is turned off;
in the first phase, the first transistor, the fourth transistor, the eighth transistor, the tenth transistor, and the twelfth transistor are all turned on; and the second transistor, the third transistor, the sixth transistor, the seventh transistor, the ninth transistor, and the eleventh transistor are all turned off; and
in the second phase, the first transistor, the fourth transistor, the eighth transistor, the tenth transistor, and the twelfth transistor are all turned off; and the second transistor, the third transistor, the sixth transistor, the seventh transistor, the ninth transistor, and the eleventh transistor are all turned on.

19. The electronic device according to claim 17, wherein
in a second operating mode, a voltage conversion ratio among the input voltage, the first output voltage, and the second output voltage is 3-2.:1, wherein the second operating mode is a mode in which the plurality of transistors switch between a first phase and a second phase; wherein
in the first phase, the first transistor, the fourth transistor, the seventh transistor, the ninth transistor, the tenth transistor, and the twelfth transistor are all turned on; and the second transistor, the third transistor, the fifth transistor, the sixth transistor, the eighth transistor, and the eleventh transistor are all turned off; and
in the second phase, the first transistor, the fourth transistor, the seventh transistor, the ninth transistor, the tenth transistor, and the twelfth transistor are all turned off; and the second transistor, the third transistor, the fifth transistor, the sixth transistor, the eighth transistor, and the eleventh transistor are all turned on.

20. The electronic device according to claim 17, wherein
in a third operating mode, a voltage conversion ratio among the input voltage, the first output voltage, and the second output voltage is 2-2.:1, wherein the third operating mode is a mode in which the plurality of transistors, except for the first transistor, the second transistor, the third transistor, and the fourth transistor, switch between a first phase and a second phase;
wherein
in the first phase and the second phase, the first transistor and the third transistor are both turned on, and the second transistor and the fourth transistor are both turned off;
in the first phase, the fifth transistor, the eighth transistor, the tenth transistor, and the twelfth transistor are all turned on; and the sixth transistor, the seventh transistor, the ninth transistor, and the eleventh transistor are all turned off; and
in the second phase, the fifth transistor, the eighth transistor, the tenth transistor, and the twelfth transistor are all turned off; and the sixth transistor, the seventh transistor, the ninth transistor, and the eleventh transistor are all turned on.
